(19) United States
(12) Patent Application Publication
(10) Pub. No.: US 2015/0048793 A1
(43) Pub. Date: Feb. 19, 2015

(54) MOTORCYCLE AND VEHICLE POWER CHARGER DEVICE CAPABLE OF INDICATING POWER LEVEL OF A BATTERY OF THE MOTORCYCLE

(71) Applicant: LONG ANN CHIU, Taipei city (TW)

(72) Inventor: LONG ANN CHIU, Taipei city (TW)

(21) Appl. No.: 13/969,621

(22) Filed: Aug. 19, 2013

(51) Int. Cl. B60L 11/18

(52) U.S. Cl. CPC B60L 11/1861
USPC 320/109

(57) ABSTRACT

A motorcycle and vehicle power charger device capable of indicating power level of a battery of the motorcycle comprises; a charging circuit board having a power charging circuit and a power capacity detector; the power capacity detector including a power capacity detection circuit and a power ranking circuit; the power capacity detection circuit serving to measure the power capacity of the power source and output a power capacity signal; the power ranking circuit being connected to the power capacity detection circuit for receiving the power capacity signal and dividing the power capacity into a plurality of ranks so as to drive a respective one of a plurality of light emitting circuits to light up so as to indicate the power capacity of the power source.

### FIELD OF THE INVENTION

The present invention relates to a power charger, and in particular to a motorcycle and vehicle power charger device capable of indicating power level of a battery of the motorcycle.

### SUMMARY OF THE INVENTION

Currently, more and more vehicle-used electronic devices are accepted by drivers, such as GPSs, MP3, path recorders, etc. which receive power from the igniter of a car.

Since the power end of the car battery is not compatible to all electronic devices, other extra adaptor with a voltage transformer is installed between the power battery and the external electronic device for matching the different specifications therebetween. However, these adaptors only have the function of power charging and the voltage transform. Furthermore, The prior art power adapter is only suitable to be used to cars. They are not suitable for being installed to motorcycles.

Since the voltages of the batteries of vehicles or motorcycles are not suitable for various kinds of electronic devices, the current used electronic devices capable of being connected to the batteries of the vehicles or motorcycles are equipped with adaptors. However, the functions of these adaptors are confined to power charging and supply.

Furthermore, these devices are aimed at vehicles instead of motorcycles. Thus it is inconvenient to motorcycle drivers. Furthermore, many of the prior art power chargers used in vehicles cannot show the power level of the batteries so that the user cannot well know the power level of the battery, while this information is helpful to drivers since the drivers can know whether the power of the battery will exhaust or whether the battery is aged so as to take precaution against the state of having no power to start the vehicle. Furthermore, they can pre-update an aged battery.

### SUMMARY OF THE INVENTION

Accordingly, for improving the above mentioned defects, the object of the present invention is to provide a motorcycle and vehicle power charger device capable of indicating power level of a battery of the motorcycle, wherein the present invention provides a novel power supply structure. In use (such as power charging to other electric or electronic device), the user can clearly know the power in the power source by the lighting of the lighting emitting circuits so as to take precaution against the state of power insufficiency.

To achieve above object, the present invention provides a motorcycle and vehicle power charger device capable of indicating power level of a battery of the motorcycle, the motorcycle having a battery as a power source ; the power charger device comprising; a charging circuit board having a power charging circuit and a power capacity detector; the power charging circuit including a power input end, a transformer, a power regulator and a power output which are connected sequentially; the power input end being connected to a power source; the transformer being connected to the power source for transforming a voltage of power from the power source to a predetermined one and then the transformed power is outputted to the power regulator for power regulation; the output power of the power regulator transformed to the power output; the power capacity detector including a power capacity detection circuit and a power ranking circuit; the power capacity detection circuit serving to measure the power capacity of the power source and output a power capacity signal; the power ranking circuit being connected to the power capacity detection circuit for receiving the power capacity signal and dividing the power capacity into a plurality of ranks so as to drive a respective one of a plurality of light emitting circuits to light up so as to indicate the power capacity of the power source.

### SUMMARY OF THE INVENTION

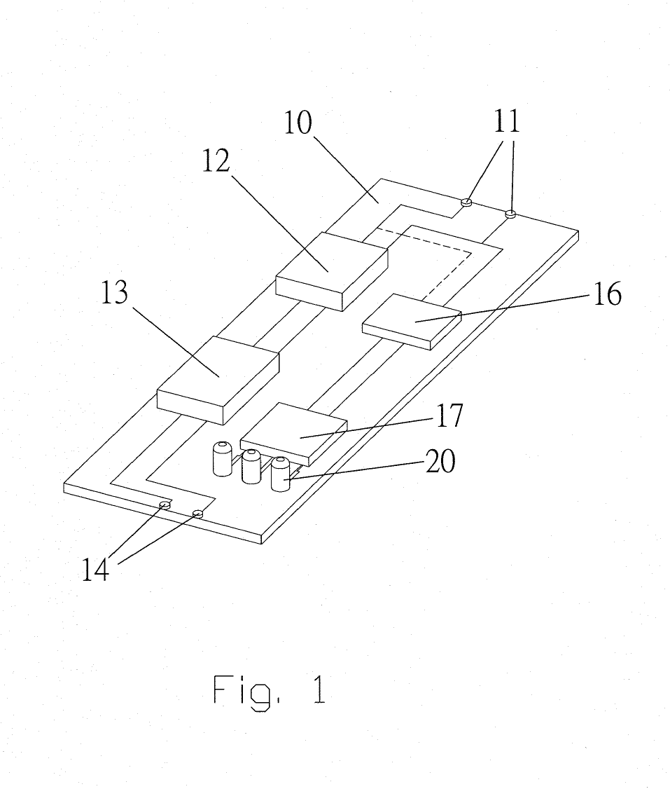

FIG. 1 is a schematic view about the power charging circuit of the present invention.

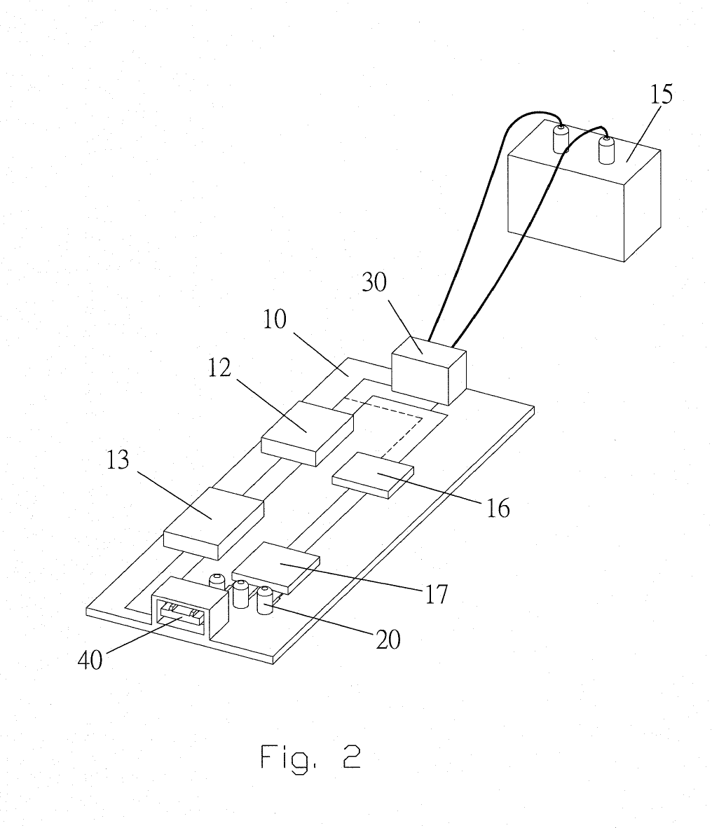

FIG. 2 is a schematic view showing that the power charging circuit of the present invention is connected to a power battery.

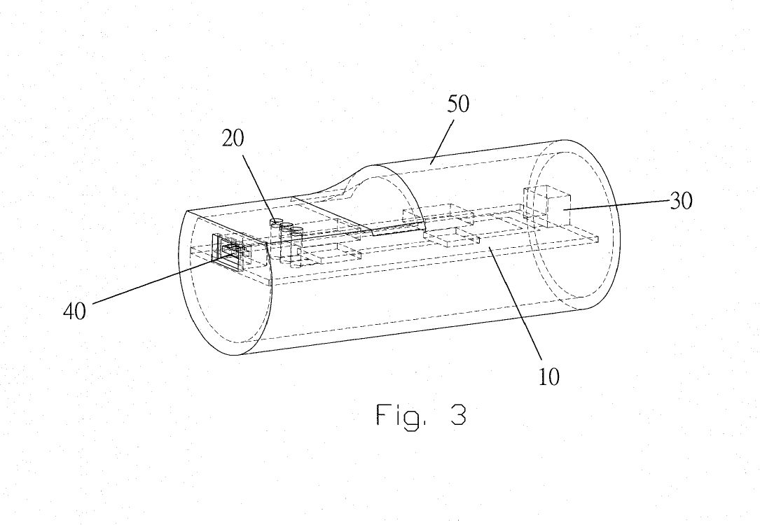

FIG. 3 is a structural schematic view of the present invention.

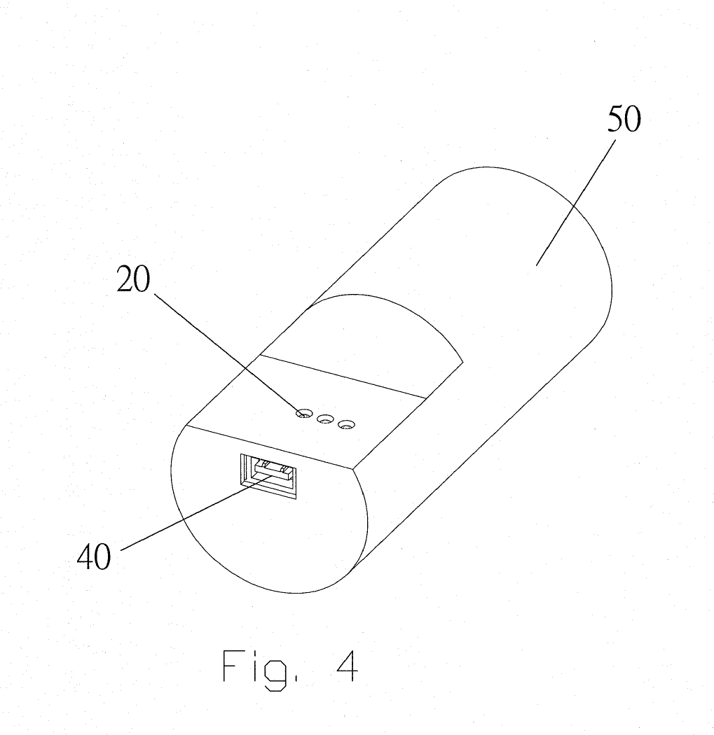

FIG. 4 is a schematic view showing the appearance of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

With reference to FIGS. 1 to 4, the structure of the present invention will be described herein. The present invention includes the following elements.

A charging circuit board 10 has a power charging circuit and a power capacity detector.

The power charging circuit includes a power input end 11, a transformer 12, a power regulator 13 and a power output 14 which are formed as a loop, The power input end 11 is connected to the power source 15. The transformer 12 is connected to the power source 15 for transform the voltage of the power from the power source 15 to a predetermined one and then the transformed power is outputted to the power regulator 13 for power regulation. The output power of the power regulator 13 is transformed to the power output 14.

The power source 15 is an electric battery of a vehicle or a motorcycle. The power capacity detector is installed between the power input end 11 and the transformer 12. The power capacity detector includes a power capacity detection circuit 16 and a power ranking circuit 17. The power capacity detection circuit 16 serves to measure the power capacity of the power source 15 and output a power capacity signal. The power ranking circuit 17 is connected to the power capacity detection circuit 16 for receiving the power capacity signal and dividing the power into a plurality of ranks to drive a respective one of a plurality of light emitting circuits 20 to light up to indicate the power capacity of the power source 15. Preferably, the power emitting circuit is a light emitting diodes.

FIG. 2 illustrates that the lighting emitting circuits 20 are installed on the power charging board 10, but this does not confine the scope of the present invention.

In the present invention, each of the plurality of lighting emitting circuits 20 may be different color so as to rank the power into several ranks.

For example, in one embodiment, colors are used to identify the ranks of the power. Each color represents one rank. For example, red color represents the power capacity is 0%˜20% of the original power capacity of the power source 15 (such as a battery of a vehicle or a motorcycle); yellow color represents the power capacity is 21%˜80% of the original power capacity of the power source 15; blue color represents the power capacity is 81%˜100% of the original power capacity of the power source 15. Therefore, a user can understand the current state of the power in the battery.

A power plug 30 is connected to the power input end 11 so that power of the power source 15 can be transferred to the power input end 11 by the power plug 30.

In the present invention, the power plug may be a power ignition head of a vehicle or a motorcycle.

A USB slot 40 is connected to the power output 14 for being connected to a USB power plug or a USB adaptor so that the output power can be transferred to a device connected to the power plug.

In the present invention, the device may be one of a handset, a PDA, a MP3 player, a tablet computer, a GPS, etc. Preferably, it is a portable electronic device.

A casing 50 serves for installing the power charging circuit, the power plug 30, and the USB slot 40. The casing 50 has a plurality of slots for receiving the power plug 30, and exposing the lighting emitting circuits 20 and the USB slot 40 therein so as to connect external electric or electronic devices.

The slot of the casing 50 for receiving the power plug 30 is matched to the ignition head of a vehicle.

One embodiment of the present invention will be described herein. The present invention can be installed to the igniter of a car. The power of the igniter is from the battery of the car. The power igniter is connected to the power plug 30 and then the power is transferred to the USB slot 40 for further connecting an external device.

Another embodiment is to apply to a motorcycle. By the structure of the present invention, the power plug of the battery of a motorcycle is connected to the power plug 30 of the present invention so that the power from the battery is transferred to the USB slot 40.

Otherwise the power capacity detection circuit 16 of the present invention can be detected the surplus power in the battery and then transfers the detected result to the lighting emitting circuits 20 so that the user can know the power of the power source 15.

The advantages of the present invention are that the present invention provides a novel power supply structure. In use (such as power charging to other electric or electronic device), the user can clearly know the power in the power source 15 by the lighting of the lighting emitting circuits 20 so as to take precaution against the state of power insufficiency.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A motorcycle power charger device capable of indicating power level of a battery of the motorcycle, the motorcycle having a battery as a power source; the power charger device comprising;
a charging circuit board having a power charging circuit and a power capacity detector;
the power charging circuit including a power input end, a transformer, a power regulator and a power output which are connected sequentially; the power input end being connected to a power source; the transformer being connected to the power source for transforming a voltage of power from the power source to a predetermined one and then the transformed power is outputted to the power regulator for power regulation; the output power of the power regulator transformed to the power output;
the power capacity detector including a power capacity detection circuit and a power ranking circuit; the power capacity detection circuit serving to measure the power capacity of the power source and output a power capacity signal; the power ranking circuit being connected to the power capacity detection circuit for receiving the power capacity signal and dividing the power capacity into a plurality of ranks so as to drive a respective one of a plurality of light emitting circuits to light up so as to indicate the power capacity of the power source.

2. The motorcycle power charger device capable of indicating power level of a battery of the motorcycle as claimed in claim 1, wherein the power emitting circuits are light emitting diodes.

3. The motorcycle power charger device capable of indicating power level of a battery of the motorcycle as claimed in claim 1, wherein the plurality of lighting emitting circuits have different colors for ranking the power into several ranks.

4. The motorcycle power charger device capable of indicating power level of a battery of the motorcycle as claimed in claim 1, further comprising:
a power plug connected to the power input end so that power of the power source is transferred to the power input end by the power plug.

5. The motorcycle power charger device capable of indicating power level of a battery of the motorcycle as claimed in claim 1, further comprising:
a casing for installing the power charging circuit, the power plug, and the USB slot therein; the casing having a plurality of slots for receiving the power plug, and exposing the lighting emitting circuits and the USB slot therein so as to connect external electric or electronic device.

6. The motorcycle power charger device capable of indicating power level of a battery of the motorcycle as claimed in claim 5, wherein a slot of the casing for receiving the power plug has a form matched to the ignition head of a vehicle.

7. The motorcycle power charger device capable of indicating power level of a battery of the motorcycle as claimed in claim 1, wherein the power capacity detector is installed between the power input end and the transformer.

8. A vehicle power charger device capable of indicating power level of a battery of the vehicle, the vehicle having a battery as a power source; the power charger device comprising;
a charging circuit board having a power charging circuit and a power capacity detector;
the power charging circuit including a power input end, a transformer, a power regulator and a power output which are connected sequentially; the power input end being connected to a power source; the transformer being connected to the power source for transforming a voltage of power from the power source to a predetermined one and then the transformed power is outputted to the power regulator for power regulation; the output power of the power regulator transformed to the power output;
the power capacity detector including a power capacity detection circuit and a power ranking circuit; the power capacity detection circuit serving to measure the power capacity of the power source and output a power capacity signal; the power ranking circuit being connected to the power capacity detection circuit for receiving the power capacity signal and dividing the power capacity into a plurality of ranks so as to drive a respective one of a plurality of light emitting circuits to light up so as to indicate the power capacity of the power source.

9. The vehicle power charger device capable of indicating power level of a battery of the vehicle as claimed in claim 8, wherein the power emitting circuits are light emitting diodes.

10. The vehicle power charger device capable of indicating power level of a battery of the vehicle as claimed in claim 8, wherein the plurality of lighting emitting circuits have different colors for ranking the power into several ranks.

11. The vehicle power charger device capable of indicating power level of a battery of the vehicle as claimed in claim 8, further comprising:
a power plug connected to the power input end so that power of the power source is transferred to the power input end by the power plug.

12. The vehicle power charger device capable of indicating power level of a battery of the vehicle as claimed in claim 8, further comprising:
a casing for containing the power charging circuit, the power plug, and the USB slot; the casing having a plurality of slots for receiving the power plug, and exposing the lighting emitting circuits and the USB slot therein so as to connect external electric or electronic device.

13. The vehicle power charger device capable of indicating power level of a battery of the vehicle as claimed in claim 12, wherein a slot of the casing for receiving the power plug has a form matched to the ignition head of a vehicle.

14. The vehicle power charger device capable of indicating power level of a battery of the vehicle as claimed in claim 8, wherein the power capacity detector is installed between the power input end and the transformer.
